(19) United States
(12) Patent Application Publication
(10) Pub. No.: US 2016/0086116 A1
(43) Pub. Date: Mar. 24, 2016

(54) METHOD AND SYSTEM OF AN AUTOMATICALLY MANAGED CALENDAR AND CONTEXTUAL TASK LIST

(71) Applicants: SUPRIYA RAO, BANGALORE (IN); SRIVATSAN LAXMAN, Bangalore (IN); SUSHIL MITTAL, SANTA CLARA, CA (US)

(72) Inventors: SUPRIYA RAO, BANGALORE (IN); SRIVATSAN LAXMAN, Bangalore (IN); SUSHIL MITTAL, SANTA CLARA, CA (US)

(21) Appl. No.: 14/810,477

(22) Filed: Jul. 27, 2015

Related U.S. Application Data
(60) Provisional application No. 62/029,542, filed on Jul. 27, 2014.
(60) Provisional application No. 62/197,556, filed on Jul. 27, 2015.

(51) Int. Cl. G06Q 10/06; G06F 3/0484

(52) U.S. Cl. CPC G06Q 10/06311; G06F 3/04845

(57) ABSTRACT

In one aspect, a computer system includes an application implemented with a computer processor that automatically discovers a list items from a set of user data sources, wherein the list items correspond to automatic recommendations for a set of calendar events and tasks, and wherein the list items are discovered programmatically in a set of email conversations and a set of calendar updates. The application extracts the list of items and metadata about the list items from the set of user data sources. The application identifies a type of each list item, wherein a set of types comprises a mandatory-action type and an informative type. The application receives a user created list of items. The application creates an electronic agenda view of the auto-recommended list of items and the user created list of items, and organizes these lists by date. The application populates the electronic agenda view with each item in the user created list of items

### CROSS-REFERENCE TO RELATED APPLICATIONS

This application claims priority to U.S. patent application No. 62/029,542, titled METHOD AND SYSTEM OF AN AUTOMATICALLY MANAGED CALENDAR AND CONTEXTUAL TASK LIST filed on 27 Jul. 2014. This application is incorporated herein by reference. This application claims priority to U.S. patent application No. 62/197,556, titled METHOD AND SYSTEM OF AN AUTOMATICALLY MANAGED CALENDAR AND CONTEXTUAL TASK LIST filed on 27 Jul. 2015. This application is incorporated herein by reference.

### BACKGROUND

1. Field

This application relates generally to computerized calendar applications, and more specifically to a system, article of manufacture and method of an automatically managed calendar and contextual task list.

2. Related Art

Users may utilize calendaring and task-management applications. These applications can provide users with an electronic version of a calendar and a todo list. Additionally, the applications may provide an appointment book, address book, and/or contact list. However, users may have to peruse various information sources (e.g. emails, text messages, etc.) and manually populate and manage the information in calendaring task-management applications. Accordingly, improvements to these applications that automatically discover and manage the user's agenda are desired.

### BRIEF SUMMARY OF THE INVENTION

In one aspect, a computer system includes an application implemented with a computer processor that automatically discovers a list items from a set of user data sources, wherein the list items correspond to automatic recommendations for a set of calendar events and tasks, and wherein the list items are discovered programmatically in a set of email conversations and a set of calendar updates. The application extracts the list of items and metadata about the list hems from the set of user data sources. The application identifies a type of each list item, wherein a set of types comprises a mandatory-action type and an informative type. The application receives a user created list of items. The application creates an electronic agenda view of the auto-recommended list of items and the user created list of items, and organizes these lists by date. The application populates the electronic agenda view with each item in the user created list of items, wherein a list of mandatory-type items are automatically graphically indicated in the electronic agenda view, wherein a list of informative type items are graphically indicated when a specified user action is detected.

### BRIEF DESCRIPTION OF THE DRAWINGS

FIG. 1 depicts an example process of generating an automatically managed contextual task list, according to some embodiments.

FIG. 2 an example computerized automated task-list manager, according to some embodiments.

FIG. 3 depicts an exemplary computing system that can be configured to perform any one of the processes provided herein.

FIG. 4 is a block diagram of a sample computing environment that can be utilized to implement various embodiments.

FIGS. 5-10 provide example user interfaces of an automatically managed contextual task list, according to some embodiments.

The Figures described above are a representative set, and are not an exhaustive with respect to embodying the invention.

### DESCRIPTION

Disclosed are a system, method, and article of manufacture of an automatically managed calendar-cum-contextual task list. The following description is presented to enable a person of ordinary skill in the art to make and use the various embodiments. Descriptions of specific devices, techniques, and applications are provided only as examples. Various modifications to the examples described herein can be readily apparent to those of ordinary skill in the art, and the general principles defined herein may be applied to other examples and applications without departing from the spirit and scope of the various embodiments.

Reference throughout this specification to “one embodiment,” “an embodiment,” ‘one example,’ or similar language means that a particular feature, structure, or characteristic described in connection with the embodiment is included in at least one embodiment of the present invention. Thus, appearances of the phrases “in one embodiment,” “in an embodiment,” and similar language throughout this specification may, but do not necessarily, all refer to the same embodiment.

Furthermore, the described features, structures, or characteristics of the invention

may be combined in any suitable manner in one or more embodiments. In the following description, numerous specific details are provided, such as examples of programming, software modules, user selections, network transactions, database queries, database structures, hardware modules, hardware circuits, hardware chips, etc., to provide a thorough understanding of embodiments of the invention. One skilled in the relevant art can recognize, however, that the invention may be practiced without one or more of the specific details, or with other methods, components, materials, and so forth. In other instances, well-known structures, materials, or operations are not shown or described in detail to avoid obscuring aspects of the invention.

The schematic flow chart diagrams included herein are generally set forth, as logical flow chart diagrams. As such, the depicted order and labeled steps are indicative of one embodiment of the presented method. Other steps and methods may be conceived that are equivalent in function, logic, or effect to one or more steps, or portions thereof, of the illustrated method. Additionally, the format and symbols employed are provided to explain the logical steps of the method and are understood not to limit the scope of the method. Although various arrow types and line types may be employed in the flow chart diagrams, and they are understood not to limit the scope of the corresponding method. Indeed, some arrows or other connectors may be used to indicate only the logical flow of the method. For instance, an arrow may indicate a waiting or monitoring period of unspecified duration between enumerated steps of the depicted method. Additionally, the order in which a particular method occurs may or may not strictly adhere to the order of the corresponding steps shown.

### Definitions

Inference Engine can be an Artificial Intelligence tool (e.g. an expert system).

Information retrieval can be the activity of obtaining information resources relevant to an information need front a collection of information resources. Searches can be based on metadata or on full-text (or other content-based) indexing. Example information retrieval methods that can be implemented herein include, inter alia: expert search finding, genomic information retrieval, geographic information retrieval, information retrieval in software engineering, and/or vertical search.

List item can be any item in an electronic calendar and/or task application user view. For example, the application user view can be a day view comprising a scrolling list of items relevant to the user. List items can be typed according to various attributes (e.g. time-bound event, task event, location-related event, high-priority event, etc.).

Machine learning can include the construction and study of systems that can learn from data. Example machine learning techniques that can be used herein include, inter alia: decision tree learning, association rule learning, artificial neural networks, inductive logic programming, support vector machines, clustering, Bayesian networks, reinforcement learning, representation learning, similarity and metric learning, and/or sparse dictionary learning.

Mobile device can include smart phones, cell phones, personal digital assistants, tablet computers, wearable computers, smart watches, smart glasses (e.g. Google Glass®), etc.

Natural language processing (NLP) can include natural language understanding and other algorithms that enable computers to derive meaning from human and/or other natural language input, NLP can also provide for natural language generation (e.g. convert information from computer databases into readable human language).

Task event can be a ‘to-do’ event, a ‘must-do’ event, a ‘may-do’ event, a ‘good to know’ event, etc.

Text message can be a form of an electronic message. Exemplary text messaging systems include, inter alia, short message service (SMS) messages, multimedia messaging service (MMS) message, instant messaging programs for mobile devices (e.g. iMessages® and the like for other mobile operating systems), email, social network messages, other proprietary text messaging applications and/or systems.

### Example Methods

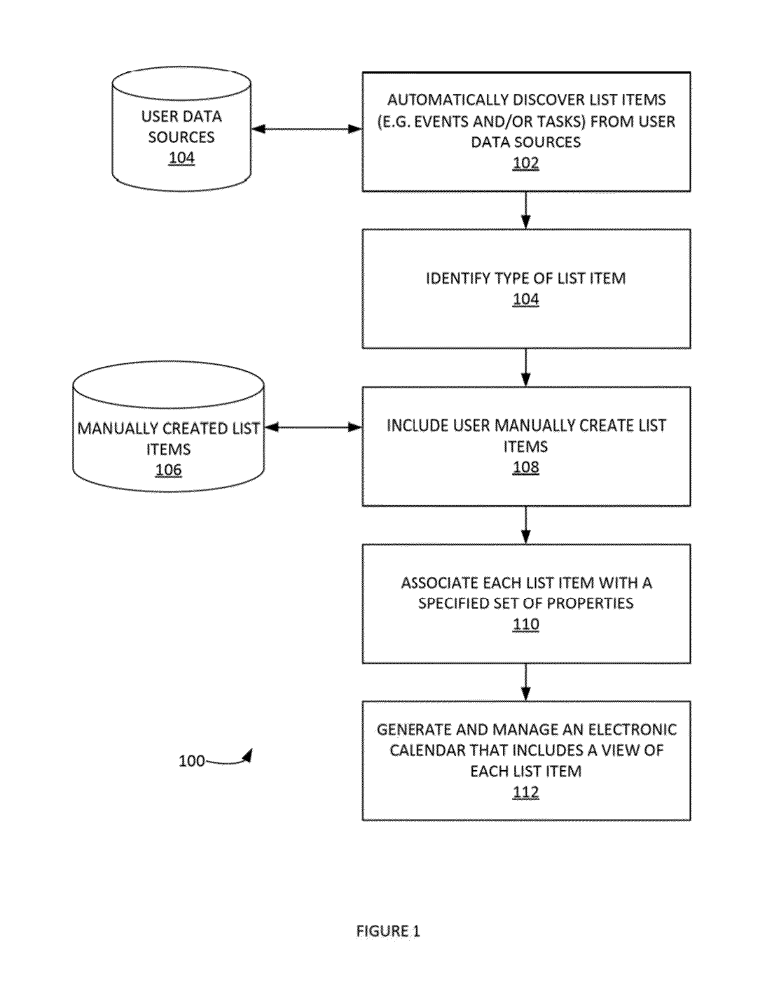

FIG. 1 depicts an example process 100 of generating an automatically

managed contextual task list, according to some embodiments. In step 102 of process 100, list items can be automatically discovered in a set of user data sources 104. In one example, a user's electronic communications (e.g. email database, text messages, etc.) can be mined to locate and extract list items and/or metadata about said list items. User data sources 104 can include online social network database, electronic communications databases, weblog databases, local host applications/databases/memory (e.g. user's mobile device text messaging application, user's mobile device task/calendar applications, and the like), etc.

For example, an email to Brian can include the statement; “Let's discuss this deal, this Tuesday at 2”. This statement can be used to create a list item for the reference Tuesday at 2 PM. Additional metadata can also be obtained. For example, the email may have been marked as a high priority email by the user's email service. Tokens in the text can also indicate high priority (e.g. ‘important’, ‘must be done’, etc.). The importance of Brian as a contact for the user can be gleaned from their communication history (e.g. how often they exchange emails or call each other, speed of user response when Brian asks a question and vice-versa, number of appointments with Brian in the recent past, whether Brian is connected to the user via one or more social networks, etc. Recent email activity levels on specific topics can provide information about the importance of the task at hand. This exemplary information can be associated with the extracted calendaring and/or task information.

Moreover, in some embodiments, each list item can be associated with one or more properties. A set of exemplary properties is now provided. A source property can refers to whether the list item was manually created, auto-generated from a calendar update, or auto-generated from an email message, etc, A title property can refers to the main description of the list-item (e.g., “Meet Kanchen”, “Respond to Sandeep”, “Pay Bill”, etc.). The title property can be easy to understand for the user, and to the extent possible, may refer to a user action. Additional properties can include, inter alia: start and end date/time (e.g. relevant for time-bound events and refers to the start and end date/times of the actual event); due date/time (e.g. relevant for ‘to-do’ events and refers to when the associated ‘to-do’ event is due); location property (e.g. can refers to the physical location where an event can occur and/or to the location trigger of a to-do item; ‘start showing on’ property (e.g. can be the date for which the list item starts appearing in a day view and time-bound events may show only for the day of the event—it is noted that this property can be determined algorithmically for some list-item types); a ‘stop showing on property (e.g. date for which the list item stops appearing in the day view, time-bound events may show up only for the day of the event); a ‘reminder date/time’ property (e.g. determines if and when to show a pop-up notification). It is noted that the various properties can be may be algorithmically determined and/or user-initiated according to the various embodiments.

In some embodiments, discovery of the following events in a user data source 104 can trigger inclusion: a time of occurrence or deadline; location of an activity; discussion of a meeting or follow up events; a call-for a commitment or other action; a temporal pattern observed in the user's communication history; etc. It is noted that, each of these events can associate with one or more token and/or token orders (e.g. word orders). An inference engine (see infra) can be utilized to determine a probability value that the event refers to a task. When the probability reaches above a specified threshold, the event information can be extracted.

In step 106, the type of list item can be identified. List items can be typed according to various attributes (e.g. time-bound event task event, location-related event, high-priority event, etc.). In one example, each primary list can be a time-bound event or a task event. A time-bound event can be an event that occurs at a specific time of the day (e.g. a meeting from 3-4 PM, cab pickup at 5 PM, etc.). A time-bound event can have a start-time and/or an end-time (it is noted that it is possible that the two can coincide for instantaneous events, e.g., cab pickup at 5 pm). Continuing with the present example, a task event can be a ‘must do’ event. For example, everything that a user needs to accomplish in a time period (e.g. present day) can be listed as a ‘must do’ task event. Unlike a time-bound event, a task event may not be associated with a specific time of the day. A task event (e.g. a ‘to-do event’) may need to get done by a specific time or day. This can be set as a deadline. A task event may need to be performed at a specified location (and/or other context). This can be typed as a location trigger (and/or other relevant context trigger). Example task; events can be, inter alia: “send the deck; by tomorrow”; “call mom on reaching home”, etc.

Secondary list-items can be determined and/or provided in the user view in addition to primary list-items. Secondary list items can be accessible in a scrolling day view. Two example types of secondary list items are now provided. A ‘may-do’ item cart include such events as, inter alia: upcoming events to be held in a city (e.g. local events such as theatre events, movie releases, concerts, sale at the local shopping mall, etc.); events relevant to the user but located elsewhere (e.g., webinars, conferences, tech-fairs, etc.) and the like. A ‘may-do item’ can have a specific date and time associated with it For example,, it can be determined that the user is interested in a set of events but is not sure whether she will attend them (e.g. hence the name ‘may-do’). User behavior can be monitored and ‘may-do’ items can be converted into primary list items. For example, in the event it is detected that the user registered for an event and/or bought tickets to a movie, these ‘may-do’ items can become primary list items to be presented in the user's primary day view (and not as a ‘may-do’ item). A user can initiate discovery of ‘may-do’ items and/or ‘may-do’ items may be visible seamlessly along with the calendars and primary list items (e.g. ‘must-do’ items) according to various embodiments.

Another category of secondary list items can be ‘good-to-know’ items. A ‘good-to-know’ item can be information received from other users and/or services that are relevant in the context of the user's day. A ‘good-to-know’ item may not include any actionable material. A ‘good-to-know’ item can be time-sensitive information for the user to remember on the given day (e.g., out of office messages, from Amazon.com® to be delivered by 5 PM today; birthday reminders, medical reminders, educational reminders, automatically tracked package deliveries, etc). A ‘good-to-know’ item may also constitute important information (e.g. communicated through email) needed when planning in advance for some future time (e.g., user's spouse is on a business trip in mid-June, senior company executive is visiting next week, etc.). A ‘good-to-know’ item can become critical information when making later plans.

In step 108, user manually created list items can be included/integrated (e.g. from a database of user manually created list items 106). For example, a user can manually create a ‘to do’ list item and manually input the relevant metadata (e.g. when, where, with whom, location, etc.). Manually created items can also be subject to natural language interpretation and AI analysis. Thus, “Dinner with Richard at 6 tomorrow” could automatically recommend a calendar entry, while “Send document to Richard” would sit in the must-do section. The user can also designate the list-item type. In step 110, an electronic agenda view (e.g. a scrolling day view as provided herein) can be created and/or managed. Each list item can be provided in the view (e.g. depending on its list-item type). For example, some list items (e.g. ‘must do’ events) can appear automatically, while other list items (e.g. ‘good to know’ items/events) can be suppressed unless user actions are detected to present said list item (e.g. a menu selection).

It is noted that, in some embodiments, visual cues can be provided in the day view (e.g. when relevant for that list item). For example, a source cue can provided a graphical indication of an origin of a list item (e.g. manual, email, calendar, etc.). Other graphical indicators can be provided for such list-item attributes as, inter alia; meeting status (e.g. confirmed or tentative); in-calendar; response-pending; propose time, urgent; conflicts; recurrence; marked as completed or otherwise pending; ‘good to know’ (e.g. an informative type) versus ‘action required’ (e.g. a mandatory-action type); now when/where a task or activity is due (e.g. context, date, time, place); etc. The following default actions can be available in the day view for of a list item: mark item as done (and unmark; may not be available for list-items originating from a calendar); delete item (or send to Trash; not available for list-items originating from a calendar); edit; etc. In addition, one or more quick actions can be associated with each list hem. These quick actions can be based on the nature of the associated task.

### Example Systems and Architecture

An automatic assistant can be provided herein can discover and manage a user's agenda based on important information contained in email conversations and calendar updates. Timely updates relevant for the user's day can be obtained from various information feeds. Accordingly, updates for the day from people and events that the user's cares about can be provided in an electronic calendar. The automatic assistant automatically detects meetings/appointments from electronic conversations and adds them to the user's electronic calendar. For example, any commitments that the user makes in an electronic communication can be automatically recognized as tasks. These tasks can be detected from emails, calendar updates, etc. Accordingly, the automatic assistant can manage a calendar-and-task application that automatically populates and manages itself. The calendar-and-task application can recommend tasks and appointments from natural language conversations. The calendar-and-task application can prioritize recommendations based on user-behavior (e.g. relevance for the day). An entity extractor can extract dates and times in natural language text; time zones; relative dates and times in conversations; names of people, places; etc. A text classifier can manage the classification of text in email conversations. Example categories can include meetings and appointments; responses due; responses awaited; commitments made; tasks delegated to others; reminders for the day; etc. A ranking engine can manage the prioritization of tasks based on importance to the user for the day. Importance can be determine based on, inter aim, past behavior of user on similar tasks; deadlines and other urgency indicators; contacts associated with the task; etc,

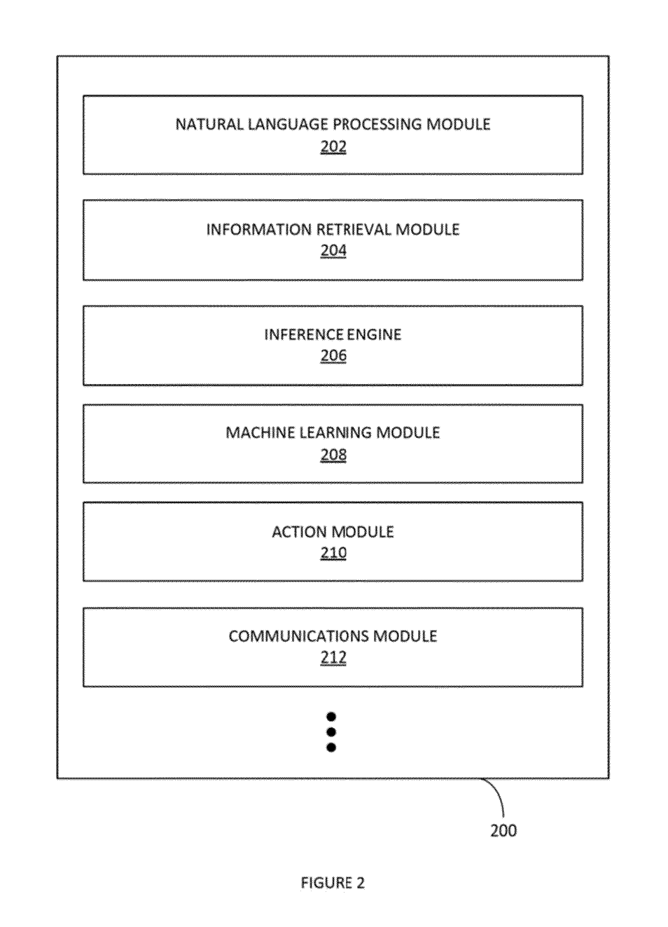

FIG. 2 an example computerized automated task-list manager 200, according to some embodiments. Task-list manager 200 can implement any automated task-list method provided herein. Task-list manager 200 can search the content of databases (e.g. electronic message databases) and obtain extract list items and/or metadata about said list items. Task-list manager 200 can determine a priority of the list items (e.g. from the context of the text of the electronic message, the content of other historical electronic messages, etc.). Task-list manager 200 can implement, process 100. In various embodiments, task-list manager 200 can be implemented on the cloud, in a server, in a virtual machine, in a client-side application and/or any combination thereof.

For example, task-list manager 200 can include a natural language processing (NLP) module 202. NLP module 202 can implement natural language understanding, part-of-speech tagging, parsing, relationship extraction, entity extraction and/or other NLP algorithms for interpreting an incoming user-generated texts.

Task-list manager 200 can include information retrieval module 204. Information retrieval module 204 can search various data sources and obtain information relevant to a user's task list. Information retrieval module 204 can include a search-engine functionality. Information retrieval module 204 can also obtain information from various third-party sources (e.g. Google® search, online social network websites, news websites, etc.). Information retrieval module 204 can pull all data that a user has permission to access. Example information sources that can be automatically discovered on a periodic basis include: email accounts (e.g. MAP (Google®, Yahoo®, iCloud®, etc.); EWS (Exchange®, Office 365®); associated calendars from email accounts (e.g. Google, iPhone, Exchange, etc.); social media sources (e.g. Facebook®, Twitter®, Linkedin®, etc. and/or messages, notifications, calendars, and/or other social media content); text message (e.g. SMS, WhatsApp®, etc.), phone-call logs, etc.

Task-list manager 200 can include an inference engine 206. Inference engine 206 can draw conclusions by analyzing user database content (e.g. user emails, online social networks, mobile device application content, text messages, etc.) in light of a database of expert knowledge it draws upon. Inference engine 206 can reach logical outcomes based on the premises the data establishes. Inference engine 206 can also utilize probability calculations to reach conclusions that the knowledge database doesn't strictly support, but instead implies. In one example, inference engine 206 can cycle through three sequential steps; match rules, select rules, and execute rules. The execution of the rules can result in new facts or goals being added to the knowledge base which will trigger the cycle to repeat. This cycle can continue until no new rules can be matched. Accordingly, a list item and its attributes can be generated and refined.

Machine learning module 208 can learn from previous user behavior with respect to previously extracted list items. This can be used to increase the accuracies of later extracted list items. For example, a user email can be searched and analyzed. It can be determined that the user has a 6 PM dinner engagement. The task-list manager 200 can determine that this is a high priority meeting (e.g. based on such factors as tokens in the email, the other participants, etc.). The task-list manger 200 can also determine other properties to associate with the dinner engagement. However, the user may manually modify the priority to ‘low priority’ and/or change other properties. Positive reinforcement may be detected in the relevance feedback if the user took steps to “complete” the task in some way, e.g., if the user added a collaborator to the task, or the user accessed the “get directions” action for the venue of a meeting, or the user called Bob when the task was “Gall Bob”, etc. Accordingly, machine learning module 208 can learn from this user behavior and modify the attributes of later list items based on this learning.

Action module 210 can enable a user to take actions on information, provided in a list item (e.g. ‘snooze’, access contact information, map information, transportation information, make restaurant reservations online, etc.). The actions exposed on a list item depends on the semantics of the corresponding task, e.g., directions-to-venue for a meeting task, but hand-off-to-bill pay-or-banking-app for a payment related task. Other example actions are provided supra. Action module 210 can enable a user manually input list items and their attributes. Action module 210 can enable a user manually modify automatically generated list items and their attributes. Action module 210 can enable a user to share list items and/or specified periods of her schedule with other users.

Communications module 212 can interact with, application programming interfaces (API) of other entities and/or various systems within an enterprise (e.g. human resources database, sales portal etc.) to obtain information. Communications module 212 can interact mobile-side client applications. Communications module 212 can obtain information from the other modules of and compose natural languages messages (e.g. emails, text messages, push notifications, augmented-reality messages, pop ops, list item text, etc) to users.

Accordingly, communications module 212 can include various human language Natural Language Generation (NLG) functionalities and/or human-language translations functionalities. Communications module 212 can also implement various context awareness methods to determine a user's current context (e.g. location, enterprise context such as position in an enterprise, calendar information, etc.).

Task-list manager 200 can include other functionalities (not shown). For example, task-list manager 200 can include a user-subscription manager, user-authentication manager, scheduling/calendar interface modules, task search, categories & filters, user registration and membership managers, etc.

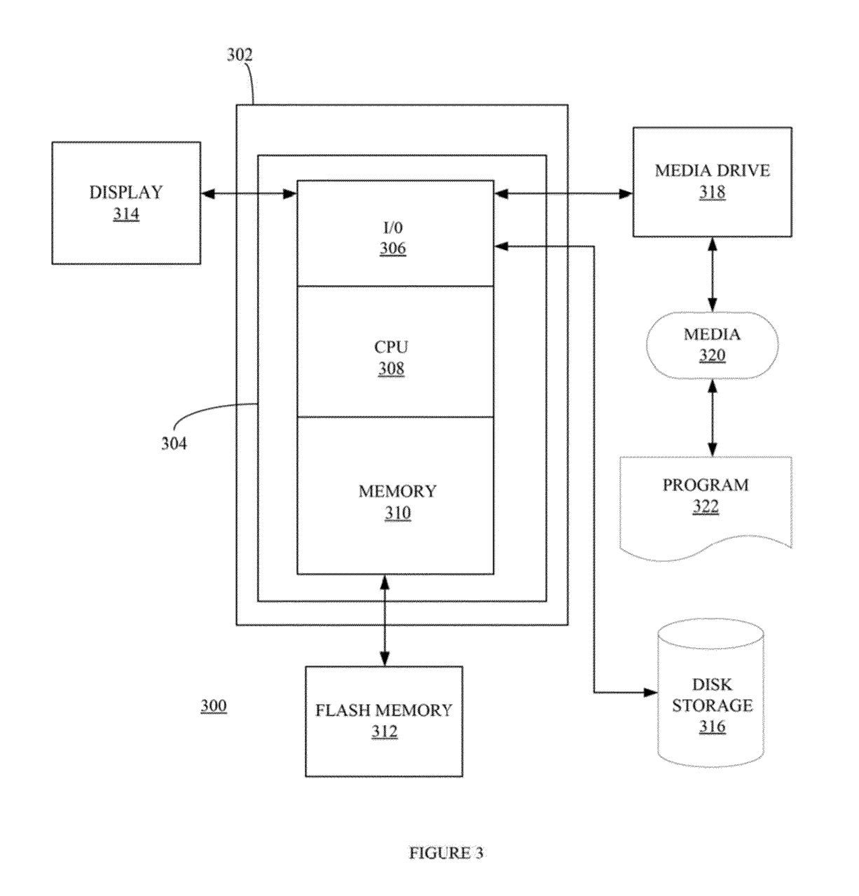

FIG. 3 depicts an exemplary computing system 300 that can be configured to perform any one of the processes provided herein. In this context, computing system 300 may include, for example, a processor, memory, storage, and I/O devices (e.g. monitor, keyboard, disk drive, internet connection, etc.). However, computing system 300 may include circuitry or other specialized hardware for carrying out some or all aspects of the processes. In some operational settings, computing system 300 may be configured as a system that includes one or more units, each of which is configured to carry out some aspects of the processes either in software, hardware, or some combination thereof.

FIG. 3 depicts computing system 300 with a number of components that may be used to perform any of the processes described herein. The main system 302 includes a motherboard 304 having an I/O section 306, one or more central processing units (CPU) 308, and a memory section 310, which may have a flash memory card 312 related to it. The I/O section 306 can be connected to a display 314, a keyboard and/or other user input (not shown), a disk storage unit 316, and a media drive unit 318. The media drive unit 318 can read/write a computer-readable medium 320, which can contain programs 322 and/or data. Computing system 300 can include a web browser. Moreover, it is noted that computing system 300 can be configured to include additional systems in order to fulfill various functionalities. Computing system 300 can communicate with other computing devices based on various computer communication protocols such a Wi-Fi, Bluetooth® (and/or other standards for exchanging data over short distances includes those using short-wavelength radio transmissions), USB, Ethernet, cellular, an ultrasonic local area communication protocol, etc.

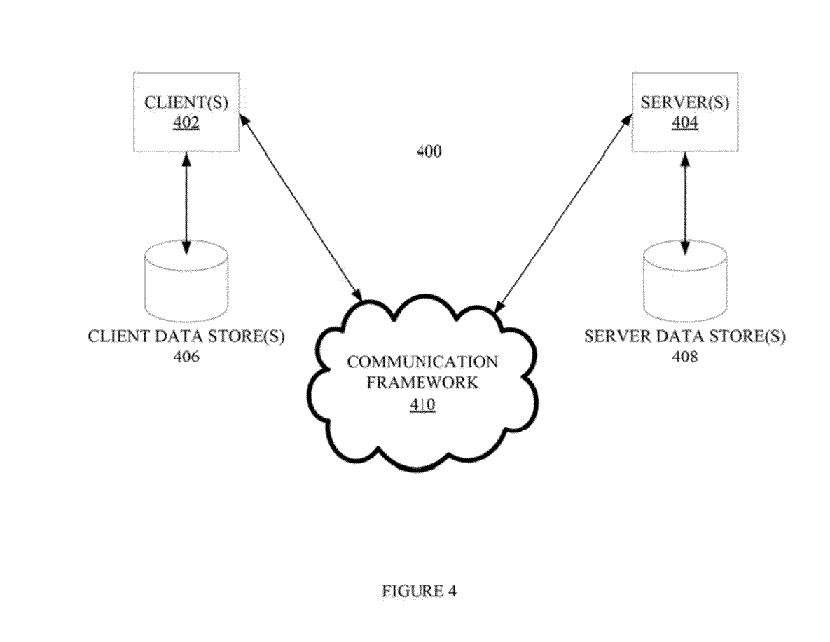

FIG. 4 is a block diagram of a sample computing environment 400 that can be utilized to implement various embodiments. The system 400 further illustrates a system that includes one or more client(s) 402. The client(s) 402 can be hardware and/or software (e.g., threads, processes, computing devices). The system 400 also includes one or more server(s) 404. The servers) 404 can also be hardware and/or software (e.g., threads, processes, computing devices). One possible communication between a client 402 and a server 404 may be in the form of a data packet adapted to be transmitted between two or more computer processes. The system 400 includes a communication framework 410 that can be employed to facilitate communications between the client(s) 402 and the server(s) 404. The client(s) 402 are connected to one or more client data store(s) 406 that can be employed to store information local to the client(s) 402. Similarly, the server(s) 404 are connected to one or more server data store(s) 408 that can be employed to store information local to the server(s) 404, In some embodiments, system 400 can instead be a collection of remote computing services constituting a cloud-computing platform. Alternatively, in some examples, system 400 can be implement in a cloud-computing environment.

### Example Use Cases

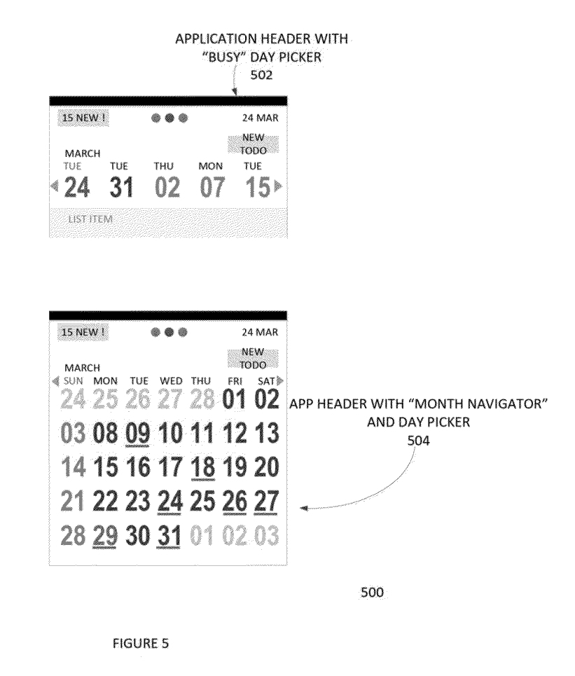

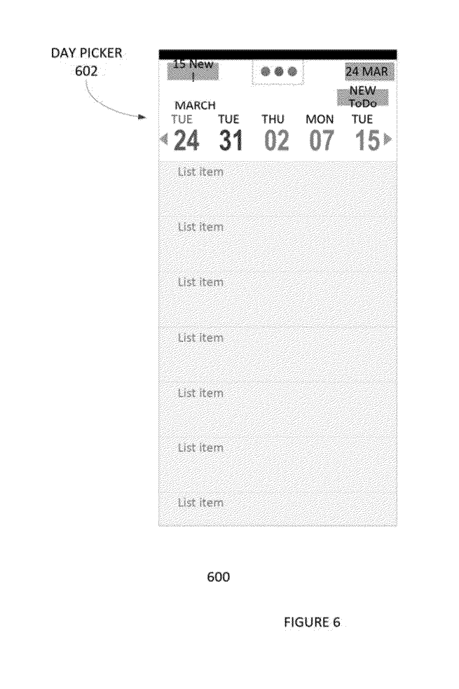

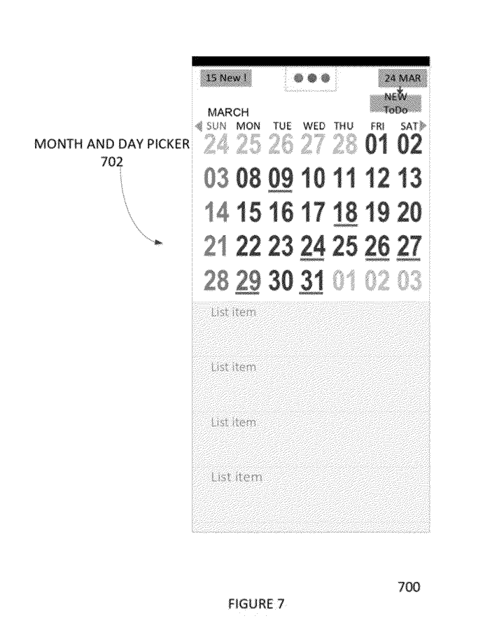

In some embodiments, the user experience for a default list view can support the following parameters. The user can view tasks by day when the default view is set as the current day. The user can navigate across days (e.g. forwards and. backwards). It is noted that when data is not available for a period beyond “x” months (e.g. backwards or forwards in time) then an. appropriate message can be provided for the user. The user can identify the task context and primary action required for each viewable list item. The user can differentiate between task types and sources. Actions associated with a task can provide adequate information about said task. The user can mark; a task as complete and/or delete a task; from their list. Appropriate visual feedback can be provided for completed tasks. FIG. 5-7 provide, inter alia, example user interface views of this functionality.

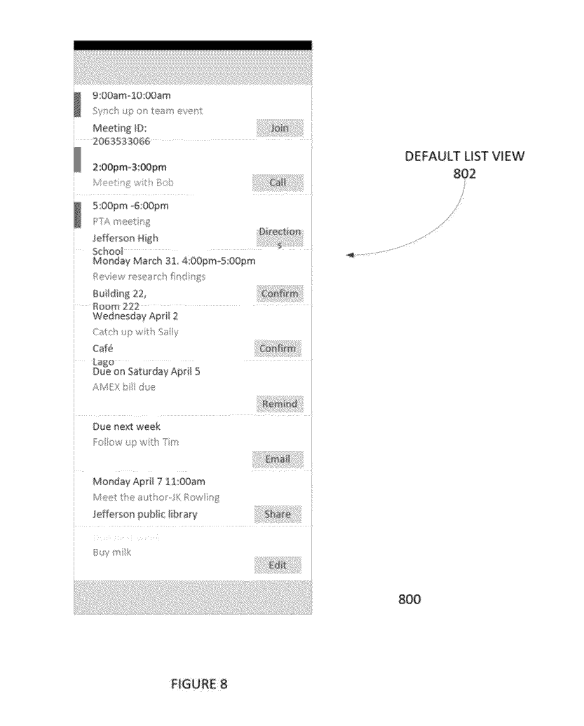

FIG. 8 provides an example user interface view of a landing page of an automatically managed contextual task; list, according to some embodiments. The landing page provides the user with an overview of her day. The user is able to see appointments from her calendar, tentative meetings, meetings being negotiated in email. ‘to-do’ tasks, ‘follow ups’, etc. This information can be automatically extracted from the user's email and/or other sources.

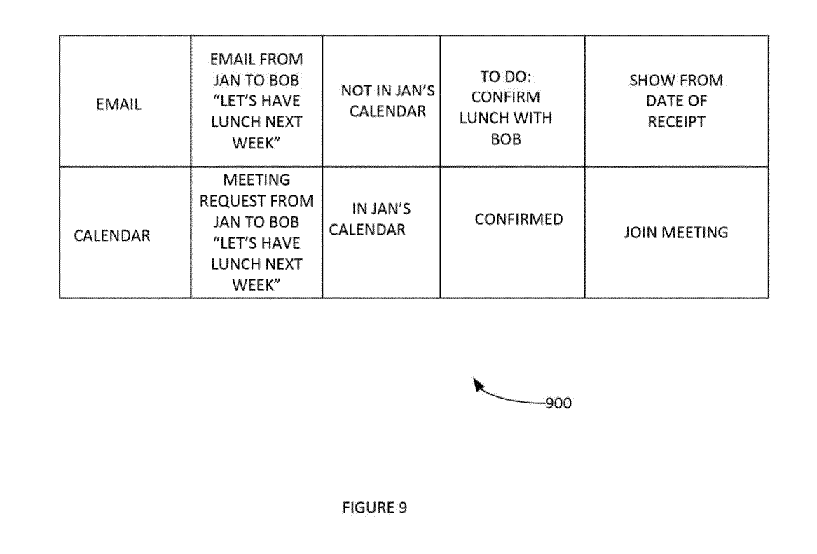

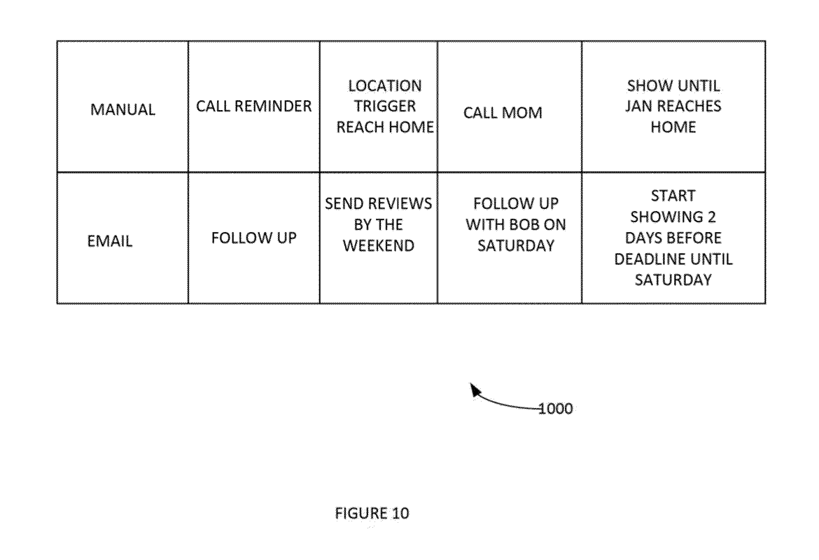

FIG. 9 provides a table used to generate a day view specification for meeting-related list-items, according to some embodiments. Meeting-related list-items, such as appointments, meeting requests and negotiations may originate in such data sources as an electronic calendar and/or in email conversations, chat or text messages, etc. Each origination case can be treated differently. Calendar-origin items can have a specific associated date and time. Email-based meeting requests and negotiations may more varied (e.g. sometimes a specific date and time is available in the email content, but there can also be email conversations about a meeting without, a specific date and/or time mentioned). Except when a meeting is confirmed on the calendar, all meeting-related items, whether through calendar or email, can initiate at least two list-items) a confirmation item (e.g. negotiation phase); and/or the actual meeting itself. All these cases are listed and treated separately in the adjoining table. FIG. 10 provides a table used to generate a day view specification for non-meeting related list-items, according to some embodiments.

### CONCLUSION

Although the present embodiments have been described with reference to specific example embodiments, various modifications and changes can be made to these embodiments without departing from the broader spirit and scope of the various embodiments. For example, the various devices, modules, etc. described herein can be enabled and operated using hardware circuitry, firmware, software or any combination of hardware, firmware, and software (e.g. embodied in a machine-readable medium).

In addition, it can be appreciated that the various operations, processes, and methods disclosed herein can be embodied in a machine-readable medium and/or a machine accessible medium compatible with a data processing system (e.g. a computer system), and can be performed in any order (e.g. including using means for achieving the various operations). Accordingly, the specification and drawings are to be regarded in an illustrative rather than, a restrictive sense. In some embodiments, the machine-readable medium can be a. non-transitory form of machine-readable medium.

What is claimed as new and desired to be protected by Letters Patent of the United States is;

1. A computer-implemented method of generating an automatically managed contextual task list comprising:
automatically discovering a list items from a set of user data sources, wherein the list items correspond to automatic recommendations for a set of calendar events and tasks, and wherein the list, items are discovered programmatically in a set of email conversations and a set of calendar updates;
extracting the list of items and metadata about the list items from the set of user data sources;
identifying a type of each list item, wherein a set of types comprises a mandatory-action type and an informative type;
receiving a user created list of items;
creating an. electronic agenda view of the list of items and the user created list of items, and wherein the list of items is auto-recommended;
organizing the list of items by a date value; and
populating the electronic agenda view with each item in the user created list of items, wherein a list of mandatory-type items are automatically graphically indicated in the electronic agenda view, wherein a list of informative type items are graphically indicated when a specified user action is detected.

2. The computer-method of claim 1, wherein, the type of each list items comprises a time-bound event, a task event, a location-related, event, and a high-priority event.

3. The computer-method of claim 2, wherein the set of user data sources comprises an online social network database, an electronic communications databases, a weblog database, and a local host application memory.

4. The computer-implemented method of claim 3, wherein the local host application memory comprises a mobile device text messaging application, and a mobile device calendar application.

5. The computer-implemented method of claim 4, wherein the electronic agenda view comprises a scrolling-day view.

6. The computer-implemented method of claim 5, wherein a graphically indicated list item comprises a meeting status indicator; an in-calendar indicator; a response-pending indicator; a proposed time indicator; an urgent indicator; a conflicts indicator; a recurrence indicator; a marked as completed indicator; or a ‘good to know’ versus ‘action required’ indicator.

7. The computer-implemented method of claim 6, wherein the list of items dynamically updates and maintains itself based on a user's communication with a relevant contact.

8. The computer-implemented method of claim 7, wherein the list of items is prioritized based on an importance of contacts associated with the item and sense of urgency detected in the language of the user data sources.

9. The computer-implemented method of claim 8 wherein the sense of urgency is detected by determining that the user data sources includes a discussion of a deadlines referenced in the user data source.

10. The computer-implemented method of claim 9, wherein the electronic agenda view is rendered for display on a mobile device's user interface.

11. A computerized system for generating an automatically managed contextual task list comprising:
a processor configured to execute instructions;
a memory including instructions when executed on the processor, causes the processor to perform operations that:
automatically discover a list items from a set of user data sources, wherein the list items correspond to automatic recommendations for a set of calendar events and tasks, and wherein the list items are discovered programmatically in a set of email conversations and a set of calendar updates;
extract the list of items and metadata about the list items from the set of user data sources;
identify a type of each list item, wherein a set of types comprises a mandatory-action type and an informative type;
receive a user-created list of items;
create an electronic agenda view of the list of items and the user created list of items, and wherein the list of items is auto-recommended;
organize the list of times by a date value of each item; and
populate the electronic agenda view with each item in the user created list of items, wherein a list of mandatory-type items are automatically graphically indicated in the electronic agenda view, wherein a list of informative type items are graphically indicated when a specified user action is detected.

12. The computerized system of claim 11, wherein the electronic agenda view is rendered for display on a mobile device's user interface.

13. The computerized system of claim 12, wherein the type of each list items comprises a time-bound event; a task event, a location-related event, and a high-priority event.

14. The computerized system of claim 13, wherein the set of user data sources comprises an online social network database, an electronic communications databases, a weblog database, and a local host application memory.

15. The computerized system of claim 14, wherein the local host application memory comprises a mobile device text messaging application, and a mobile device calendar application.

16. The computerized system of claim 15, wherein the electronic agenda view comprises a scrolling-day view.

17. The computerized system of claim 16, wherein a graphically indicated list item comprises a meeting status indicator; an in-calendar indicator; a response-pending indicator; a proposed time indicator; an urgent indicator; a conflicts indicator; a recurrence indicator; a marked as completed indicator; or a ‘good to know’ versus ‘action required’ indicator.

18. The computerized system of claim 17, wherein the list of items dynamically updates and maintains itself based on a user's communication with a relevant contact.

19. The computerized system of claim 18, wherein the list of items is prioritized, based on an importance of contacts associated with the item and sense of urgency detected in the language of the user data sources.

20. The computerized system of claim 19, wherein the sense of urgency is detected by determining that the user data sources includes a discussion of a deadlines referenced in the user data source.
